(19) United States
(12) Patent Application Publication
(10) Pub. No.: US 2020/0117929 A1
(43) Pub. Date: Apr. 16, 2020

(54) METHOD FOR GENERATING BACKGROUND IMAGE FOR USER MONITORING IN VEHICLE AND APPARATUS THEREFOR

(71) Applicant: LG Electronics Inc., Seoul (KR)

(72) Inventor: JunHo MOON, Seoul (KR)

(21) Appl. No.: 16/714,251

(22) Filed: Dec. 13, 2019

(30) Foreign Application Priority Data
Aug. 20, 2019 (KR) 10-2019-0101983

(51) Int. Cl. G06K 9/00; G06K 9/38

(52) U.S. Cl. CPC G06K 9/00832; G06K 9/00362; G06K 9/38

(57) ABSTRACT

A method includes receiving the latest position information from at least one position-changeable apparatus of a plurality of apparatuses of the vehicle; acquiring a first image for the interior of the vehicle; generating a background image based on the latest position information and the first image; acquiring a second image for the interior of the vehicle in a state in which the user rides in the vehicle; and segmenting an image for the user riding in the vehicle based on a differential image between the background image and the second image. The background image may be generated by reflecting a position for an apparatus changed by the user. One or more of an autonomous vehicle, a user terminal and a server of the present invention may be associated with an artificial intelligence module, a drone robot, augmented reality device, a virtual reality device, and a device related to 5G services.

### CROSS-REFERENCE TO RELATED APPLICATION

This application claims priority to Korean Application No. 10-2019-0101983, filed on Aug. 20, 2019, the contents of which are hereby incorporated by reference herein in their entirety.

### BACKGROUND OF THE INVENTION

### Field of the Invention

The present invention relates to autonomous driving systems, and more particularly, to a method for generating a background image for monitoring a user in a vehicle and an apparatus therefor.

### Related Art

Vehicles may be classified into an internal combustion engine vehicle, an external combustion engine vehicle, a gas turbine vehicle, an electric vehicle, and the like according to the type of motor used.

An autonomous vehicle refers to a vehicle that can run on its own without manipulation of a driver or passenger, and automated vehicle & highway systems refers to a system that monitors and controls such an autonomous vehicle to operate on its own.

In order to monitor (recognize) a user (e.g., driver) behavior, an image in the vehicle may be acquired using a sensor of the vehicle. However, when the image or information acquired by the sensor of the vehicle is used as it is, it may take a long time to separate a user image. In addition, when the user image is incorrectly segmented, there is a high probability of error in user behavior monitoring (recognition).

### SUMMARY OF THE INVENTION

The present invention aims to solve the aforementioned needs and/or problems.

The present invention provides a method for generating a background image for monitoring a user in a vehicle in autonomous driving systems.

The present invention also provides a method for generating a background image by receiving information on an apparatus including information on the latest position through a CAN protocol from the apparatus with respect to a position-changeable apparatus among in-vehicle apparatuses, when generating the background image.

Objects of the present invention are not limited to the above-mentioned objects. That is, other objects that are not mentioned may be obviously understood by those skilled in the art to which the present invention pertains from the following description.

In an aspect, a method for monitoring an interior of the vehicle by the vehicle in autonomous driving systems is provided. The method includes receiving the latest position information from at least one position-changeable apparatus of a plurality of apparatuses of the vehicle; acquiring a first image for the interior of the vehicle in a state in which a user does not ride in the vehicle; generating a background image based on the latest position information and the first image; acquiring a second image for the interior of the vehicle in a state in which the user rides in the vehicle; and segmenting an image for the user riding in the vehicle based on a differential image between the background image and the second image.

The latest position information may be received through a communication system in the vehicle, and the communication system in the vehicle may use one protocol of Controller Area Network (CAN), Local Interconnect Network (LIN), FlexRay, Media Oriented Systems Transport (MOST), and Ethernet.

The method may further include, when a plurality of users ride in the vehicle, receiving the number of the users and position information of the users based on a seat sensor of the vehicle. The method may further include generating a background image for each user by combining information on the user with the background image.

The latest position information may be received whenever a position of the at least one position-changeable apparatus is changed.

The first image and the second image may be acquired from an infrared camera of the vehicle.

The method may further include correcting the background image.

The correcting of the background image may be performed by recognizing the presence or absence of the user in the vehicle and updating a difference between the pre-generated background image and the first image to the pre-generated background image when the user does not ride in the vehicle.

The recognition of the presence or absence of the user may be recognized based on a pressure sensor or a seat belt tension sensor of the vehicle.

The background image may be generated by reflecting the latest position information to a predefined base image of the at least one position-changeable apparatus to generate a result image, and combining the result image with the first image. The predefined base image of the at least one position-changeable apparatus may be received through a wireless communication network.

The vehicle may implement at least one advanced driver assistance system (ADAS) function based on a signal for controlling a movement of the vehicle.

In another aspect, a vehicle monitoring the interior of the vehicle in autonomous driving systems is provided. The vehicle includes a communication module; a memory; and a processor configured to be functionally connected to the communication module and the memory, wherein the processor is configured to monitor the interior of the vehicle by: receiving the latest position information from at least one position-changeable apparatus of a plurality of apparatuses of the vehicle; acquiring a first image for the interior of the vehicle in a state in which a user does not ride in the vehicle; generating a background image based on the latest position information and the first image; acquiring a second image for the interior of the vehicle in a state in which the user rides in the vehicle; and segmenting an image for the user riding in the vehicle based on a differential image between the background image and the second image.

The latest position information may be received through a communication system in the vehicle, and the communication system in the vehicle may correspond to one protocol of Controller Area Network (CAN), Local Interconnect Network (LIN), FlexRay, Media Oriented Systems Transport (MOST), and Ethernet.

The vehicle may generate a background image for each user by combining information on the user with the background image.

The vehicle may further receive the number of users and position information on the users based on a seat sensor of the vehicle, when a plurality of users ride in the vehicle. The latest position information may be received whenever a position of the at least one position-changeable apparatus is changed.

The first image and the second image may be acquired from an infrared camera of the vehicle.

The vehicle may further perform a correction for the background image.

The correction may be performed by recognizing the presence or absence of the user in the vehicle and updating a difference between the pre-generated background image and the first image to the pre-generated background image when the user does not ride in the vehicle.

The recognition of the presence or absence of the user may be recognized based on a pressure sensor or a seat belt tension sensor of the vehicle.

The background image may be generated by reflecting the latest position information to a predefined base image of the at least one position-changeable apparatus to generate a result image, and combining the result image with the first image. The predefined base image of the at least one position-changeable apparatus may be received through a wireless communication network. The vehicle may implement at least one advanced driver assistance system (ADAS) function based on a signal for controlling a movement of the vehicle.

### BRIEF DESCRIPTION OF THE DRAWINGS

The accompanying drawings, which are included as part of the detailed description in order to provide a thorough understanding of the present invention, provide examples of the present invention and together with the description, describe the technical features of the present invention.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present invention.

FIG. 6 is a control block diagram of the vehicle according to an embodiment of the present invention.

FIG. 7 illustrates a frame structure of a CNN.

FIG. 8 is a control block diagram of an autonomous device according to an embodiment of the present invention.

FIG. 9 is a diagram showing a signal flow in an autonomous vehicle according to an embodiment of the present invention.

FIG. 10 is a diagram illustrating the interior of a vehicle according to an embodiment of the present invention.

FIG. 11 is a block diagram referred to in description of a cabin system for a vehicle according to an embodiment of the present invention.

FIG. 12 is a diagram referred to in description of a usage scenario of a user according to an embodiment of the present invention.

FIG. 13 shows an example of a summary plot for the method proposed in the present invention and a method for generating a background image and utilizing the same according to an embodiment.

FIG. 14 illustrates an example of the method proposed in the present invention and the generation of a background image according to an embodiment.

FIGS. 15A and 15B illustrates an example of a generation of a background image to which a movement of a seat and a change of state are reflected.

FIG. 16 illustrates an example of an operation of a configuration diagram of a vehicle that may operate according to the above-described method and embodiment.

FIG. 17 illustrates an example of an operation flowchart of a vehicle to which the above-described method and embodiment are applicable.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

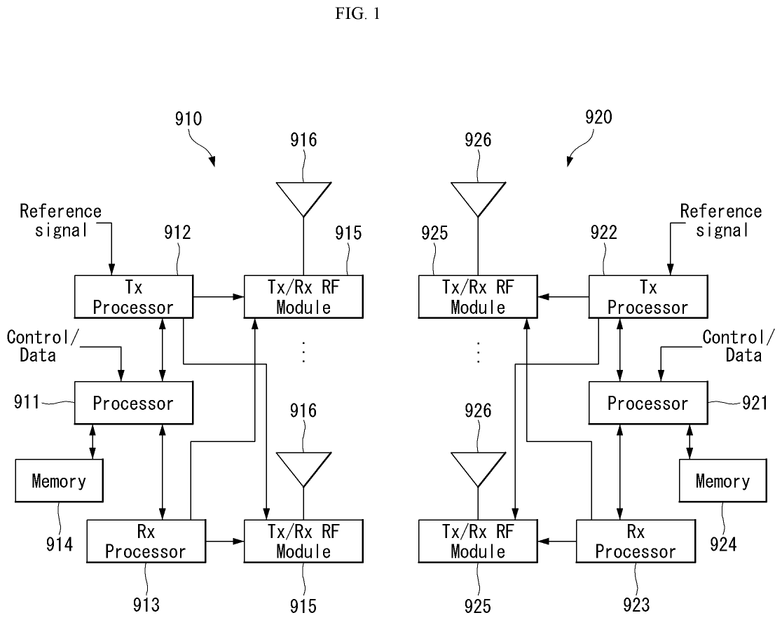

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

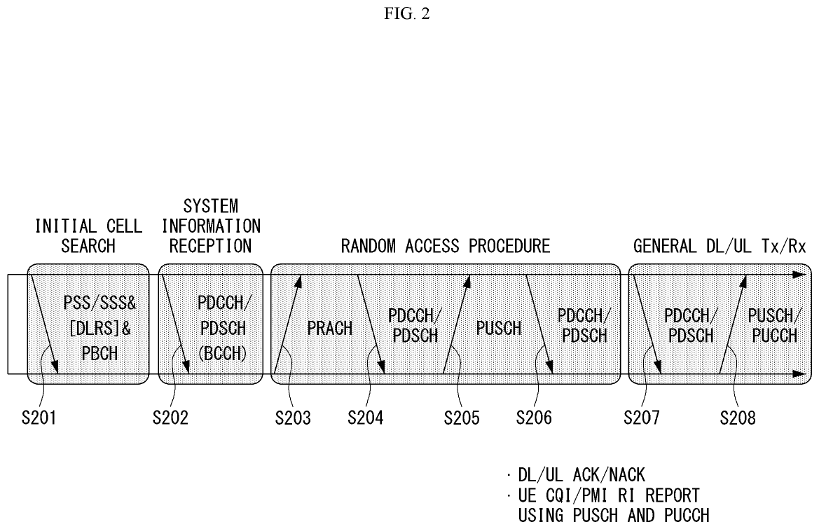

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the B S or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

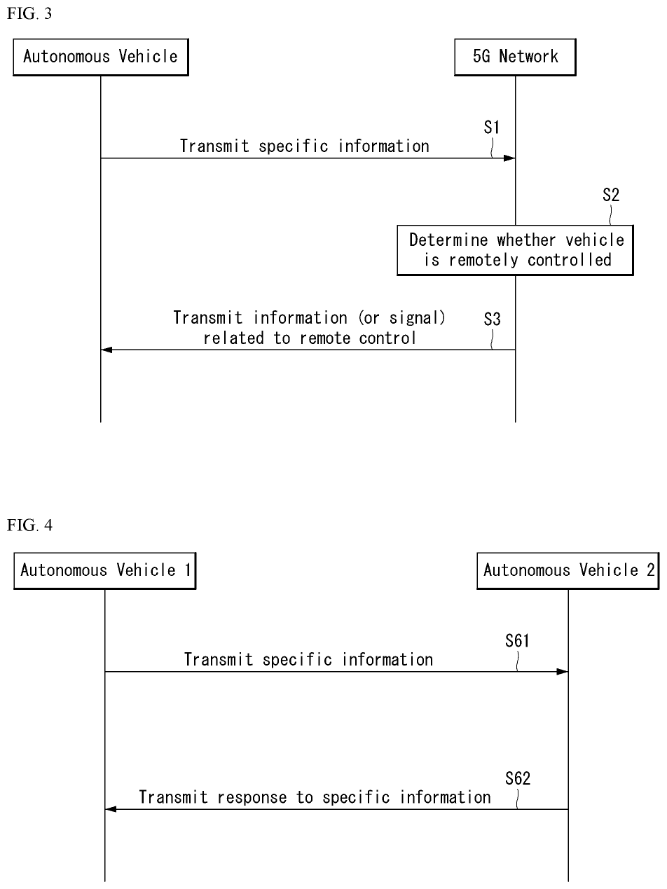

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

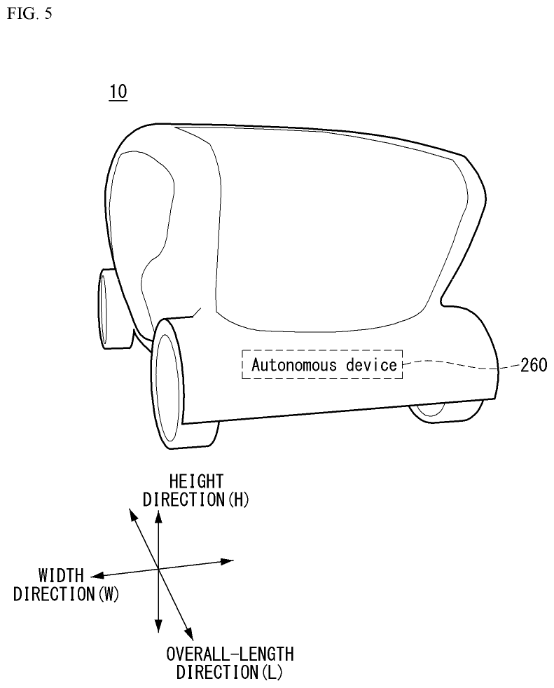

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

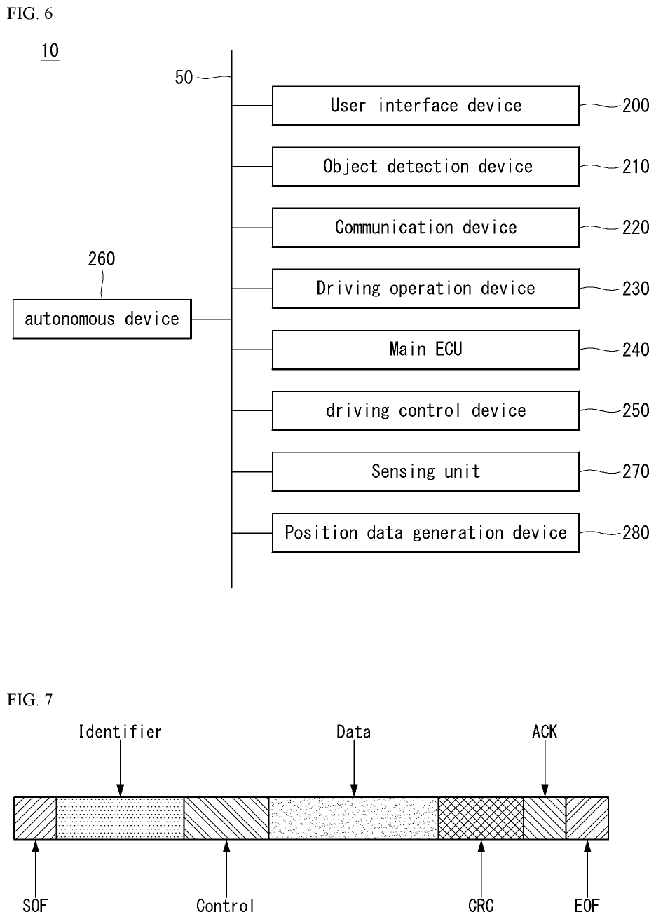

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

Hereinafter, a controller area network (CAN) protocol will be described in detail.

The CAN is one mode of communication protocols of the vehicle and is a communication method of transmitting and receiving data by connecting a plurality of electronic control units (ECUs) in parallel to each other. The data may be distributed on a communication line through a CAN bus and necessary data may be accessed. The CAN bus is a multi master mode and the communication bus may be shared and used by a plurality of nodes. In addition, the CAN bus is constituted by two lines, which are resistant to electrical noise and simple to implement. The ECUs of the vehicle have unique ID values, and may receive priorities by receiving ID values set through filtering in the CAN.

The CAN may transmit data in a frame packet consisting of multiple fields or bits. FIG. 7 illustrates a frame structure of the CAN. Referring to FIG. 7, in the frame structure of the CAN, a start of frame (SOF) corresponds to a bit indicating the start of data. Identifiers (IDs) identify the content of the data and indicate the priority of the ECUs. Control indicates a length (DLC) of the data, DATA indicates data to be transmitted, and CRC may be used to detect an error. Acknowledgment (ACK) indicates whether data was transmitted without error. End of Frame (EOF) indicates the end of a frame.

(3) Components of Autonomous Device

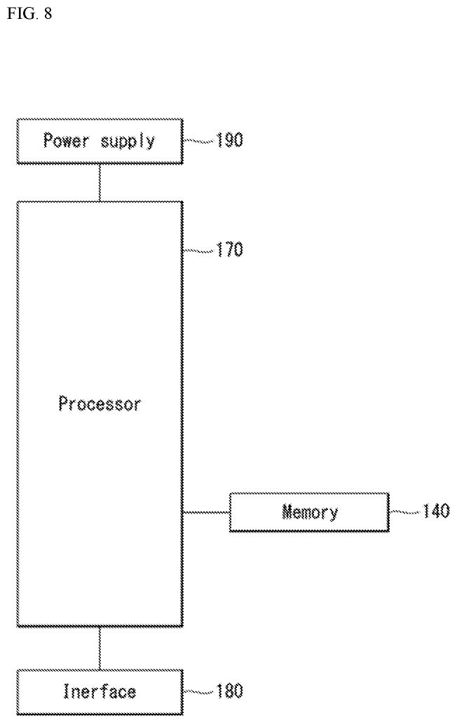

FIG. 8 is a control block diagram of the autonomous device according to an embodiment of the present invention.

Referring to FIG. 8, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

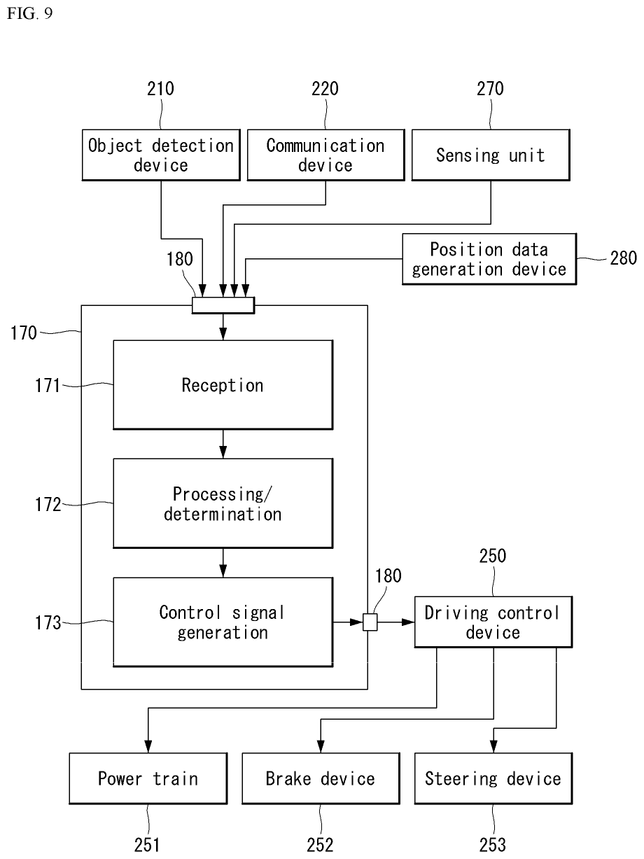

FIG. 9 is a diagram showing a signal flow in an autonomous vehicle according to an embodiment of the present invention.

1) Reception Operation

Referring to FIG. 9, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Cabin

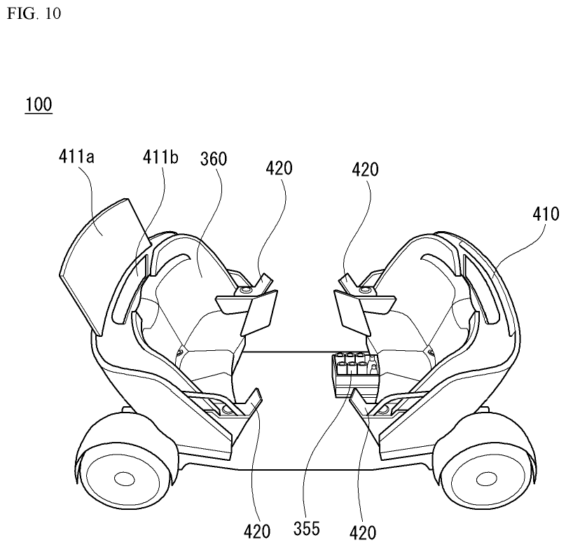

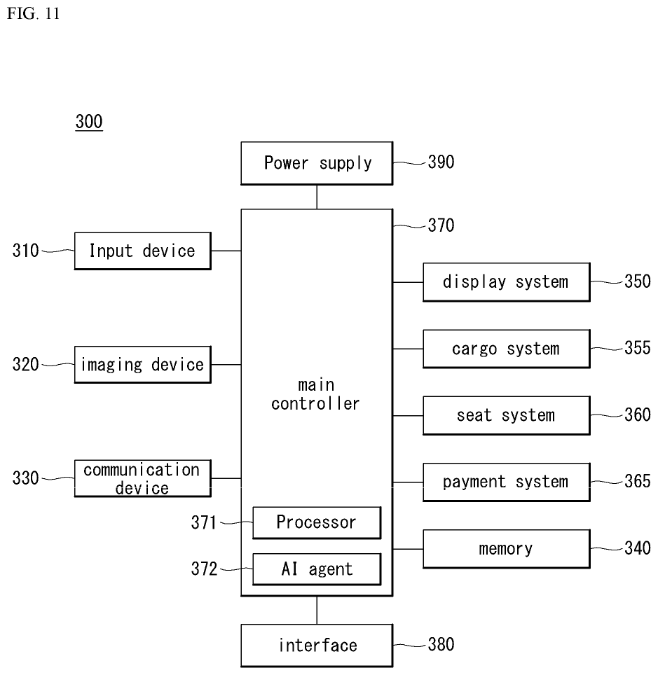

FIG. 10 is a diagram showing the interior of the vehicle according to an embodiment of the present invention. FIG. 11 is a block diagram referred to in description of a cabin system for a vehicle according to an embodiment of the present invention.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

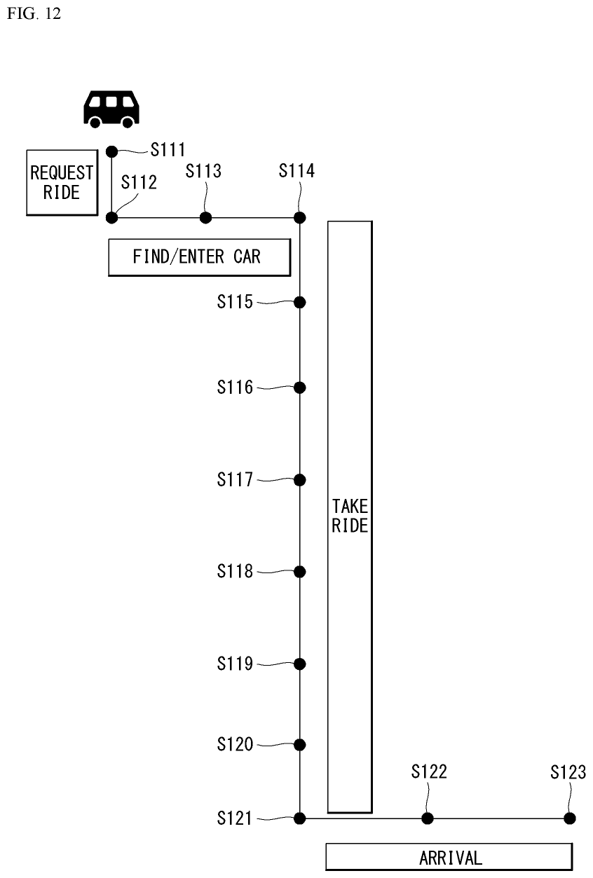

FIG. 12 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

The above-describe 5G communication technology can be combined with methods proposed in the present invention which will be described later and applied or can complement the methods proposed in the present invention to make technical features of the present invention concrete and clear.

Hereinafter, various embodiments of the present invention will be described in detail with reference to the attached drawings.

In addition to the above-described various scenarios, a necessary service may be provided by monitoring the behavior of the user of the vehicle or the like. That is, in order to provide a vehicle usage environment optimized to the user, the monitoring (recognizing) for the behavior of the user may be required. In order to monitor the user, the perception (recognition) of the user by monitoring the interior of the vehicle needs to be preceded, and to this end, a background image in the vehicle may be used. By monitoring the interior of the vehicle using the background image in the vehicle and efficiently extracting an image of the user (e.g., driver and passenger), it is possible to accurately recognize the behavior of the user.

The background image in the vehicle may need to be changed according to the user of the vehicle. For example, when the user changes or moves a location of at least one apparatus in the vehicle, a previously generated background image may not be used. Specifically, when the user changes a position of the seat (chair) and a handle of the vehicle, the background image generated before the change may no longer be used, and it is necessary to newly generate (update) the background image.

Hereinafter, the present invention proposes a method for generating a background image in a vehicle in order to monitor the interior of the vehicle. In particular, when the position of at least one apparatus in a vehicle is changed or moved, a method for efficiently generating a background image in a vehicle is proposed.

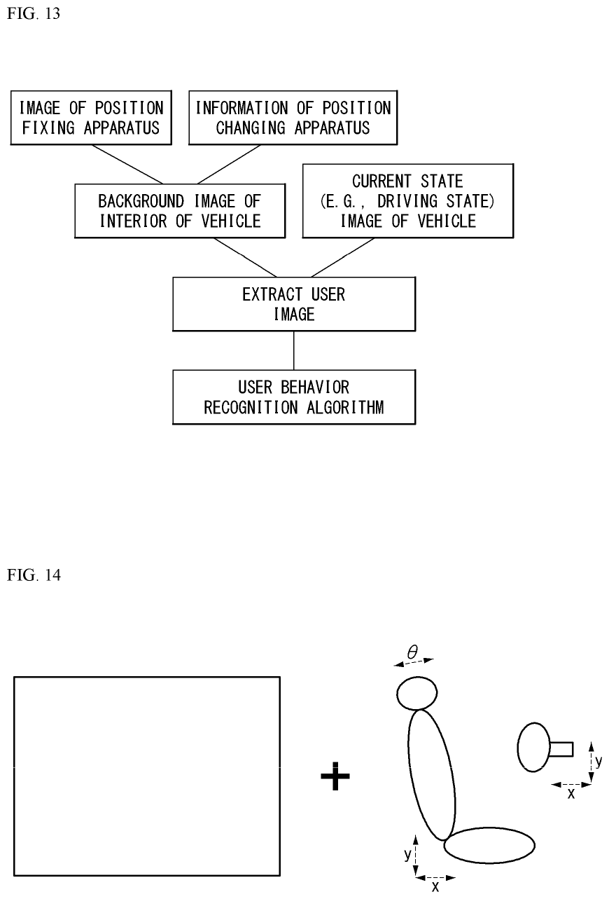

FIG. 13 shows an example of a summary plot for the method proposed in the present invention and a method for generating a background image and utilizing the same according to an embodiment. Referring to FIG. 13, a background image of the interior of the vehicle may be generated by combining an image for a position fixing apparatus in the vehicle with information on a position changing apparatus in the vehicle. In addition, an image of a user may be extracted (segmented) based on the background image of the interior of the vehicle and a current state (e.g., driving state) image of the vehicle. A user behavior recognition algorithm may be performed for the recognized user. In the following, each step will be described in detail based on a method for efficiently generating a background image.

When the background image of the interior of the vehicle is generated, it is necessary to consider to the latest position of a position-changeable apparatus among the in-vehicle apparatuses. For example, a position of a seat system 360, a display system 350, a driving manipulation apparatus 230 (e.g., a steering input apparatus), or the like among the in-vehicle apparatuses is changeable by the user. However, this is merely an example for convenience of explanation and does not limit the scope of the present invention. Therefore, it is apparent that the present invention may be applied to other position-changeable in-vehicle apparatuses.

The vehicle may receive information on each apparatus including the latest position of each apparatus from the position-changeable apparatuses among the in-vehicle apparatuses. The information on each apparatus including the latest position of each apparatus may be transmitted through the internal communication system 50 included in the vehicle 10. The internal communication system 50 may use the CAN protocol. In addition, the information on each apparatus including the latest position of each apparatus may be newly received whenever a change in position of the apparatus occurs.

As a specific example, information of a seat position (e.g., height, forward and backward, backrest angle, and headrest) and a steering wheel (e.g., height and forward and backward) of the vehicle may be transmitted to a processor of the vehicle using the CAN protocol of the internal communication system of the vehicle. When the user changes the positions of the seat and the steering wheel while driving, information on the corresponding apparatuses including new position information may be newly received.

In order to generate the background image, a base background image (e.g., first image) for the interior of the vehicle may be generated. The base background image may be generated except for the position-changeable apparatuses among the in-vehicle apparatuses. Alternatively, the base background image may be generated in a state in which initial position information of the position-changeable apparatuses among the in-vehicle apparatuses is reflected.

The base background image may be generated based on information acquired from at least one apparatus in the vehicle. For example, the base background image may be generated based on information acquired through at least one apparatus of a sensing unit 270 or an imaging device 320 of the vehicle. The sensing unit 270 may generate vehicle state data based on data detected by various sensors included in the vehicle. In addition, the imaging device 320 may include a camera and acquire an internal image of the vehicle through the camera in the vehicle. Here, in order to minimize an influence according to the lighting in the vehicle, an infrared (IR) camera may be used. The IR camera may minimize an influence on visible light because of separately disposing infrared lighting. An infrared image and/or a 3D depth image may be acquired using the camera in the vehicle. The base background image may be generated based on the vehicle state data, the infrared image, the 3D depth image, and the like.

The vehicle may generate the background image by combining the base background image with the received information on each apparatus including the latest position of each apparatus. FIG. 14 shows an example of the method proposed in the present invention and the generation of a background image according to an embodiment. Referring to FIG. 14, the background image may be generated by combining the base background image with position information of the seat.

Specifically, the background image matched to a current state may be generated by receiving the latest position information of the seat position (e.g., height, forward and backward, backrest angle, and headrest) and the steering wheel position (e.g., height and forward and backward) from each apparatus through the CAN protocol and then combining the latest position information with the base background image. Thereby, even though the user changes the positions of the in-vehicle apparatuses (e.g., a seat and a handle), the background image according to the change may be updated in real time and applied.

The generated background image may need to be corrected in some cases. The present or absence of the user in the vehicle is detected, and if the user is not in the vehicle, the correction may be performed. For example, the present or absence of the user on each seat may be recognized through a pressure sensor or seat belt tension sensor of the vehicle, and each sensor may transmit a recognition result to the processor of the vehicle through the CAN protocol. If the user is not in the vehicle, the correction may be performed by comparing the background image and a current image acquired from the camera of the vehicle and reflecting a difference between the background image and the current image to the background image.

An infrared image and/or a 3D depth image may be acquired from the camera in the vehicle and used to monitor the interior of the vehicle. In order to monitor the behavior of the user in the vehicle, the driver behavior recognition algorithm may calculate a difference between the background image and an image acquired through the imaging device (e.g., camera) in the vehicle and separate a background and the user from each other. Thereby, it is easy to find the position of the user and the things in the vehicle. By utilizing the background image in a segmentation portion of the recognition algorithm, a speed of the algorithm may be increased and an error probability for user recognition may be lowered, thereby improving a performance of the recognition algorithm.

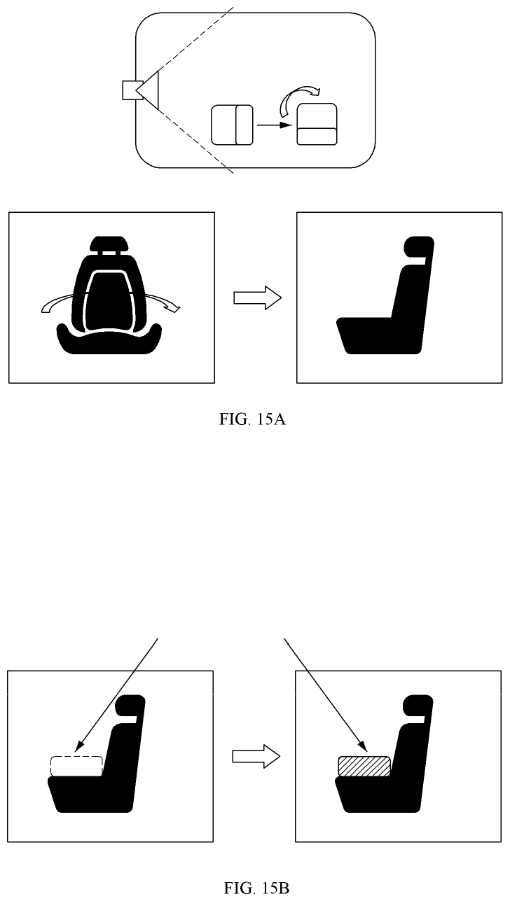

Hereinafter, specific examples to which the methods proposed in the present invention are applicable will be described. However, this is merely for convenience of explanation and does not limit the scope of the present invention. FIGS. 15A and 15B illustrates an example of a generation of a background image to which a movement of a seat and a change of state are reflected. FIG. 15A will be described in detail in Case 1 and FIG. 15B will be described in detail Case 3.

<Case 1>

FIG. 15A illustrates an example of generating a background image by reflecting a movement and rotation of a seat using a 3D image of the seat.

Referring to FIG. 15A, the background image may be generated by reflecting the movement and rotation of the seat of an autonomous vehicle. In the autonomous vehicle, the seat may be capable of rotating as well as moving forward, backward, up and down. The processor of the vehicle may receive information on the movement and rotation of the seat from a seat apparatus or a seat system 360 of a cabin through the CAN protocol, and may generate a background image of a current state by combining the received information with a base background image. In this case, an initial state 3D image for the seat may be included in the base background image. Alternatively, a 3D image for the seat may be stored in a memory of the vehicle. The processor may receive information on a height, a forward and backward, a backrest angle, a headrest, and the rotation of the seat from the seat apparatus or the seat system 360 of the cabin, and may generate a new background image by perform a conversion and a combination for a pre-stored 3D image of the seat.

<Case 2>

A plurality of background images may be generated depending on a vehicle usage environment. For example, the background images may be generated by dividing the vehicle usage environment into a day mode and a night mode according to time. Alternatively, the background images may be generated according to a seat position, a user's arrangement, and a user's posture in each mode by dividing the vehicle usage environment into each of the usage cases such as a normal mode, a rest mode, a video conference mode, and the like. To this end, a plurality of base background images may also be generated for each of the modes. According to each mode, the background image may be generated based on a 3D image to which the base background image and the position change of the seat and the handle are reflected. By generating the background image for each of the modes, the error probability may be lowered at the time of performing the segmentation for user recognition.

<Case 3>

FIG. 15B illustrates an example in which a correction on the background image is necessary because a cover is on the seat. Referring to FIG. 15B, in the autonomous vehicle, an error may occur in the background image by covering the seat with the cover or cushioning the seat. In this case, the correction of the error (including the seat and the cushion in the background image) may be necessary. The present or absence of the user on each seat may be recognized through one of a pressure sensor or a seat belt tension sensor of the vehicle, and the processor of the vehicle may receive a recognition result through the CAN protocol. Even if there is no user, if there is a difference between the background image and the current 3D image acquired by the camera, the correction may be performed by applying the difference to the background image.

<Case 4>

In a case in which there are a plurality of users in the vehicle, when some features are hidden or overlapped at a certain angle, it may be difficult to distinguish the users from the background. In this case, the number of users and the position of the users may be determined based on additional vehicle information (e.g., seat sensor) and may be used to distinguish the users from the background.

<Case 5>

A background image for a specific (authenticated) user (e.g., car owner) may be generated. The specific user may be determined through separate authentication (e.g., fingerprint, key, iris, etc.) and data learning, the background image for the corresponding user may be generated to check whether or not the user wears accessories (e.g., sunglasses) and a change in dress of the user, and the background image may be utilized to distinguish the background from the user based on those described above.

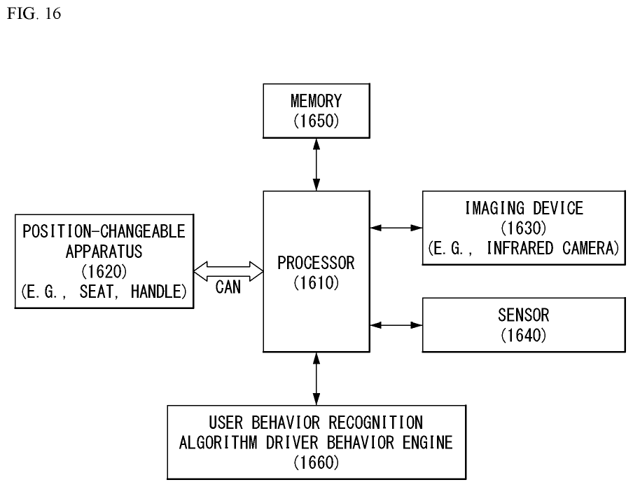

FIG. 16 illustrates an example of an operation of a configuration diagram of a vehicle that may operate according to the above-described method and embodiment. FIG. 16 is merely an example for describing the present invention and does not limit the scope of the present invention. It is assumed that the vehicle is a vehicle running in autonomous driving systems. In addition, the vehicle may implement at least one advanced driver assistance system (ADAS) function based on a signal for controlling a movement of the vehicle.

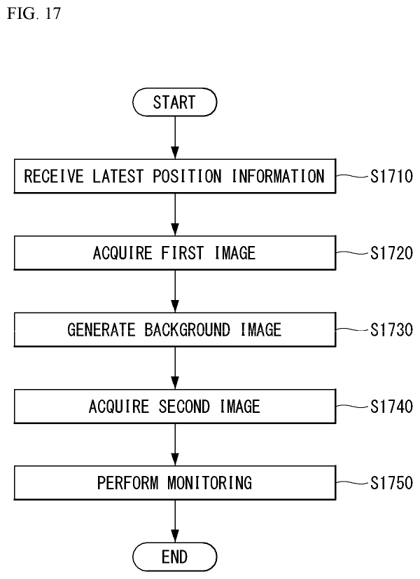

Referring to FIG. 16, the vehicle 1600 may include a processor 1610, a position-changeable apparatus 1620, an imaging device 1630, a sensor 1640, a memory 1650 for storing data, and a driver behavior engine 1660 capable of performing a user behavior recognition algorithm. The processor 1610 may be functionally connected to the remaining apparatuses of the vehicle. In addition, the processor 1610 may communicate with the position-changeable apparatus 1620 using the CAN protocol. The position-changeable apparatus 1620 may include at least one of a seat and a handle (steering wheel). The imaging device 1630 may include an infrared camera. The sensor 1640 may include at least one of a pressure sensor, a seat belt tension sensor, and a seat sensor. An operation of the vehicle will be described in detail in a description of FIG. 17 below.

FIG. 17 illustrates an example of an operation flowchart of a vehicle to which the above-described method and embodiment are applicable. FIG. 17 is merely an example for describing the present invention and does not limit the scope of the present invention. Some steps of FIG. 17 may be omitted, replaced, or merged, and some orders may be changed. The vehicle may correspond to the vehicle of FIG. 16. The operation of the vehicle below may be controlled by the processor 1610 of the vehicle.

The vehicle 1600 may receive the latest position information from at least one position-changeable apparatus of a plurality of apparatuses of the vehicle in order to monitor its interior (S1710). For example, the at least one position-changeable apparatus 1620 may include a seat system, a display system, and a driving manipulation apparatus (e.g., a steering input apparatus). As a specific example, the at least one position-changeable apparatus 1620 may include a seat and a handle (steering wheel) of the vehicle.

The latest position information may be received through an in-vehicle communication system. As an example, the in-vehicle communication system may use at least one protocol of CAN, LIN, FlexRay, MOST, and Ethernet. In addition, the latest position information may be received whenever a position of the at least one position-changeable apparatus is changed. Thereby, even if the user changes the position of the apparatus, the background image may be generated by reflecting the changed position. As a specific example, the latest position information may include information on a seat position (e.g., height, forward and backward, backrest angle, and headrest) and a steering wheel (e.g., height and forward and backward) of the vehicle.

The vehicle 1600 may acquire a first image for the interior thereof (S1720). For example, the first image may be generated except for the apparatus that transmits the latest position information. In addition, the first image may be generated in a state in which the user does not ride in the vehicle. Alternatively, the first image may be generated in a state in which initial position information of the at least one position-changeable apparatus is reflected.

The first image may be generated based on information acquired from at least one apparatus in the vehicle. For example, the first image may be generated based on data detected by various sensors 1640 included in the vehicle. In addition, the first image may be acquired through the imaging device 1630 in the vehicle. Here, the imaging device 1630 may include a camera, and the camera may be an infrared (IR) camera in order to minimize an influence according to the lighting in the vehicle.

The vehicle 1600 may generate the background image based on the latest position information and the first image (S1730). The background image may be generated by reflecting the latest position information to a predefined base image of the at least one position-changeable apparatus to generate a result image and combining the result image with the first image. The predefined base image of the at least one position-changeable apparatus may be received through a wireless communication network. As a specific example, a background image of a current state may be generated by combining the latest position information of the seat position (e.g., height, forward and backward, backrest angle, and headrest) and the steering wheel position (e.g., height and forward and backward) from each apparatus through the CAN protocol with the first image.

As another example, a background image for each user may also be generated by combining information on the user with the background image. In addition, when a plurality of users ride in the vehicle, the number of the users and position information of the users may be received based on a seat sensor of the vehicle.

The vehicle 1600 may acquire a second image for the interior thereof (S1740). The second image may be generated based on information acquired from at least one apparatus in the vehicle. For example, the second image may be generated based on data detected by various sensors included in the vehicle. In addition, the second image may be acquired through the camera in the vehicle. Here, in order to minimize an influence according to the lighting in the vehicle, an infrared (IR) camera may be used. In addition, the second image may be an image acquired in a state in which the user rides in the vehicle. The second image may be generated for each boarding timing of each user. For example, when three of the users of the shuttle bus ride at the first stop, the second image may be obtained first at the time of the first ride. When two people board the second stop, the second image may be additionally acquired at the second boarding time point. If the user does not board at a some stop, the second image may not be obtained at the corresponding stop time.

The vehicle 1600 may monitor the interior of the vehicle based on a differential image between the background image and the second image (S1750). As an example, the vehicle 1600 may segment (recognize) an image for the user riding in the vehicle by comparing the background image and the second image with each other. The behavior recognition algorithm 1660 may operate based on the recognized user.

The vehicle 1600 may also correct the background image. The correction may be performed by recognizing the presence or absence of the user in the vehicle and updating a difference between the pre-generated background image and the first image to the pre-generated background image when the user does not ride in the vehicle. The recognition of the presence or absence of the user may be recognized based on a pressure sensor or a seat belt tension sensor of the vehicle, and a recognition result may be transmitted to the processor of the vehicle through the CAN protocol.

Hereinafter, various embodiments for the method for generating a background image for monitoring a user in a vehicle in autonomous driving systems according to an embodiment of the present invention will be described.

An embodiment 1: a method for monitoring an interior of the vehicle by the vehicle in autonomous driving systems is provided. The method includes receiving the latest position information from at least one position-changeable apparatus of a plurality of apparatuses of the vehicle; acquiring a first image for the interior of the vehicle in a state in which a user does not ride in the vehicle; generating a background image based on the latest position information and the first image; acquiring a second image for the interior of the vehicle in a state in which the user rides in the vehicle; and segmenting an image for the user riding in the vehicle based on a differential image between the background image and the second image.

An embodiment 2: In the method of the embodiment 1, the latest position information may be received through a communication system in the vehicle, and the communication system in the vehicle may use one protocol of Controller Area Network (CAN), Local Interconnect Network (LIN), FlexRay, Media Oriented Systems Transport (MOST), and Ethernet.

An embodiment 3: The method of the embodiment 1 may further include, when a plurality of users ride in the vehicle, receiving the number of the users and position information of the users based on a seat sensor of the vehicle. An embodiment 4: The method of the embodiment 1 may further include generating a background image for each user by combining information on the user with the background image.

An embodiment 5: In the method of the embodiment 1, the latest position information may be received whenever a position of the at least one position-changeable apparatus is changed.

An embodiment 6: In the method of the embodiment 1, the first image and the second image may be acquired from an infrared camera of the vehicle.

An embodiment 7: The method of the embodiment 1 may further include correcting the background image.

An embodiment 8: In the method of the embodiment 7, the correcting of the background image may be performed by recognizing the presence or absence of the user in the vehicle and updating a difference between the pre-generated background image and the first image to the pre-generated background image when the user does not ride in the vehicle.

An embodiment 9: In the method of the embodiment 8, the recognition of the presence or absence of the user may be recognized based on a pressure sensor or a seat belt tension sensor of the vehicle.

An embodiment 10: In the method of the embodiment 1, the background image may be generated by reflecting the latest position information to each predefined base image of the at least one position-changeable apparatus to generate a result image and combining the result image with the first image. An embodiment 11: In the method of the embodiment 10, the predefined base image of the at least one position-changeable apparatus may be received through a wireless communication network. An embodiment 12: In the method of the embodiment 1, the vehicle may implement at least one advanced driver assistance system (ADAS) function based on a signal for controlling a movement of the vehicle.

An embodiment 13: A vehicle monitoring the interior of the vehicle in autonomous driving systems is provided. The vehicle includes a communication module; a memory; and a processor configured to be functionally connected to the communication module and the memory, wherein the processor is configured to monitor the interior of the vehicle by: receiving the latest position information from at least one position-changeable apparatus of a plurality of apparatuses of the vehicle; acquiring a first image for the interior of the vehicle in a state in which a user does not ride in the vehicle; generating a background image based on the latest position information and the first image; acquiring a second image for the interior of the vehicle in a state in which the user rides in the vehicle; and segmenting an image for the user riding in the vehicle based on a differential image between the background image and the second image.

An embodiment 14: In the vehicle of the embodiment 13, the latest position information may be received through a communication system in the vehicle, and the communication system in the vehicle may correspond to one protocol of Controller Area Network (CAN), Local Interconnect Network (LIN), FlexRay, Media Oriented Systems Transport (MOST), and Ethernet.

An embodiment 15: The vehicle of the embodiment 13 may further receive the number of users and position information on the users based on a seat sensor of the vehicle, when a plurality of users ride in the vehicle. An embodiment 16: The vehicle of the embodiment 13 may generate a background image for each user by combining information on the user with the background image. An embodiment 17: In the vehicle of the embodiment 13, the latest position information may be received whenever a position of the at least one position-changeable apparatus is changed.

An embodiment 18: In the vehicle of the embodiment 13, the first image and the second image may be acquired from an infrared camera of the vehicle.

An embodiment 19: The vehicle of the embodiment 13 may further perform a correction for the background image.

An embodiment 20: In the vehicle of the embodiment 19, the correction may be performed by recognizing the presence or absence of the user in the vehicle and updating a difference between the pre-generated background image and the first image to the pre-generated background image when the user does not ride in the vehicle.

An embodiment 21: In the vehicle of the embodiment 20, the recognition of the presence or absence of the user may be recognized based on a pressure sensor or a seat belt tension sensor of the vehicle.

An embodiment 22: In the vehicle of the embodiment 13, the background image may be generated by reflecting the latest position information to each predefined base image of the at least one position-changeable apparatus to generate a result image and combining the result image with the first image. An embodiment 23: In the vehicle of the embodiment 13, the predefined base image of the at least one position-changeable apparatus may be received through a wireless communication network. An embodiment 24: In the vehicle of the embodiment 13, the vehicle may implement at least one advanced driver assistance system (ADAS) function based on a signal for controlling a movement of the vehicle.

The present invention described above may be implemented with a computer readable code in a medium in which a program is recorded. A computer readable medium may include all kinds of recording devices in which data that may be read by a computer system are stored. An example of the computer readable medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disk, an optical data storage device, or the like, and also include a medium implemented in the form of a carrier wave (for example, transmission through the Internet). Therefore, the above detailed description should not be construed as limiting in all respects but should be considered as illustrative. The scope of the invention should be determined by reasonable interpretation of the appended claims, and all changes within the equivalent scope of the invention are included in the scope of the invention.

In addition, the above description has been made with reference to the embodiments, which are merely examples and are not intended to limit the present invention, and it will be appreciated by those skilled in the art to which the present invention pertains that various modifications and applications illustrated in the above are possible without departing from the essential characteristics of the present embodiment. For example, each component specifically illustrated in the embodiments may be modified. In addition, differences related to such modifications and applications should be construed as being included in the scope of the invention as defined in the appended claims.

According to an embodiment of the present invention, the background image may be generated in the autonomous driving systems, and the user in the vehicle may be monitored based on the generated background image.

In addition, according to an embodiment of the present invention, the background image reflecting an exact position of the apparatus may be generated by receiving the information on the apparatus including the information on the latest position through the CAN protocol from the apparatus with respect to the position-changeable apparatus among the in-vehicle apparatuses, when generating the background image.

In addition, according to an embodiment of the present invention, the speed and accuracy of the segmentation for user recognition may be improved by reflecting the latest position of the in-vehicle apparatus to generate the background image.

The effects obtainable in the present invention are not limited to the above-mentioned effects, and other effects that are not mentioned may be obviously understood by those skilled in the art to which the present invention pertains from the following description.

What is claimed is:

1. A method for monitoring an interior of the vehicle by the vehicle in autonomous driving systems, the method comprising:
receiving the latest position information from at least one position-changeable apparatus of a plurality of apparatuses of the vehicle;
acquiring a first image for the interior of the vehicle;
generating a background image based on the latest position information and the first image;
acquiring a second image for the interior of the vehicle in a state in which at least one user rides in the vehicle; and
segmenting an image for the user riding in the vehicle based on a differential image between the background image and the second image.

2. The method of claim 1, wherein the latest position information is received through a communication system in the vehicle, and
the communication system in the vehicle uses one protocol of Controller Area Network (CAN), Local Interconnect Network (LIN), FlexRay, Media Oriented Systems Transport (MOST), and Ethernet.

3. The method of claim 1, further comprising, receiving the number of the users and position information of the users based on a seat sensor of the vehicle when a plurality of users ride in the vehicle.

4. The method of claim 3, wherein the second image may be generated for each boarding timing of each user.

5. The method of claim 1, further comprising generating a background image for each user by combining information on the user with the background image.

6. The method of claim 1, wherein the latest position information is received whenever a position of the at least one position-changeable apparatus is changed.

7. The method of claim 1, wherein the first image and the second image are acquired from an infrared camera of the vehicle.

8. The method of claim 1, further comprising correcting the background image.

9. The method of claim 8, wherein the correcting of the background image is performed by updating a difference between the pre-generated background image and the first image to the pre-generated background image.

10. The method of claim 9, wherein the correcting of the background image is performed before a user's boarding, and
wherein the user's boarding is recognized based on a pressure sensor or a seat belt tension sensor of the vehicle.

11. The method of claim 1, wherein the background image is generated by reflecting the latest position information to a predefined base image of the at least one position-changeable apparatus to generate a result image, and combining the result image with the first image.

12. The method of claim 11, wherein the predefined base image of the at least one position-changeable apparatus is received through a wireless communication network.

13. The method of claim 1, wherein the vehicle implements at least one advanced driver assistance system (ADAS) function based on a signal controlling a movement of the vehicle.

14. A vehicle monitoring the interior of the vehicle in autonomous driving systems, the vehicle comprising:
a communication module;
a memory; and
a processor configured to be functionally connected to the communication module and the memory,
wherein the processor is configured to monitor the interior of the vehicle by:
receiving the latest position information from at least one position-changeable apparatus of a plurality of apparatuses of the vehicle;
acquiring a first image for the interior of the vehicle;
generating a background image based on the latest position information and the first image;
acquiring a second image for the interior of the vehicle in a state in which the user rides in the vehicle; and
segmenting an image for the user riding in the vehicle based on a differential image between the background image and the second image.

15. The vehicle of claim 14, wherein the latest position information is received through a communication system in the vehicle, and
the communication system in the vehicle corresponds to one protocol of Controller Area Network (CAN), Local Interconnect Network (LIN), FlexRay, Media Oriented Systems Transport (MOST), and Ethernet.

16. The vehicle of claim 14, wherein the vehicle further receives the number of users and position information on the users based on a seat sensor of the vehicle, when a plurality of users ride in the vehicle.

17. The vehicle of claim 16, wherein the second image may be generated for each boarding timing of each user.

18. The vehicle of claim 14, wherein the vehicle generates a background image for each user by combining information on the user with the background image.

19. The vehicle of claim 14, wherein the latest position information is received whenever a position of the at least one position-changeable apparatus is changed.

20. The vehicle of claim 14, wherein the first image and the second image are acquired from an infrared camera of the vehicle.

21. The vehicle of claim 14, wherein the vehicle further performs a correction for the background image.

22. The vehicle of claim 20, wherein the correction is performed by updating a difference between the pre-generated background image and the first image to the pre-generated background image.

23. The vehicle of claim 22, wherein the correcting of the background image is performed before a user's boarding, and
wherein the user's boarding is recognized based on a pressure sensor or a seat belt tension sensor of the vehicle.

24. The vehicle of claim 14, wherein the background image is generated by reflecting the latest position information to a predefined base image of the at least one position-changeable apparatus to generate a result image, and combining the result image with the first image.

25. The vehicle of claim 14, wherein the predefined base image of the at least one position-changeable apparatus is received through a wireless communication network.

26. The vehicle of claim 14, wherein the vehicle implements at least one advanced driver assistance system (ADAS) function based on a signal controlling a movement of the vehicle.
